(19) United States
(12) Patent Application Publication
(10) Pub. No.: US 2020/0034776 A1
(43) Pub. Date: Jan. 30, 2020

(54) MANAGING SKILLS AS CLUSTERS USING MACHINE LEARNING AND DOMAIN KNOWLEDGE EXPERT

(71) Applicant: INTERNATIONAL BUSINESS MACHINES CORPORATION, Armonk, NY (US)

(72) Inventors: Michael PERAN, Scarsdale, NY (US); Brian JOHNSTON, Sleepy Hollow, NY (US); Charlie WANG, Mountain View, CA (US); Pankaj SRIVASTAVA, Bedford, NY (US); Ben ZWEIG, New York, NY (US)

(73) Assignee: INTERNATIONAL BUSINESS MACHINES CORPORATION, Armonk, NY (US)

(21) Appl. No.: 16/045,230

(22) Filed: Jul. 25, 2018

(51) Int. Cl. G06Q 10/06; G06Q 10/04; G06N 5/04; G06N 99/00; G06K 9/62

(52) U.S. Cl. CPC G06Q 10/063112; G06Q 10/04; G06K 9/6218; G06N 99/005; G06N 5/04

(57) ABSTRACT

Embodiments for managing skills as a cluster using machine learning and a domain knowledge expert by a processor. An adjacency of one or more target skills and one or more skills of each of a plurality of entities may be determined. The adjacency of skills may be used to generate one or more skill clusters. One or more domain knowledge experts may be used to correct the one or more skill clusters. The skill clusters corrected by the domain knowledge experts may be used to correct the skill adjacencies. The corrected skill adjacencies may be used to select candidates for reskilling. A skill demand of the one or more skill clusters may be forecasted.

### BACKGROUND OF THE INVENTION

### Field of the Invention

The present invention relates in general to computing systems, and more particularly, to various embodiments for managing skills as clusters using machine learning and one or more domain knowledge experts using a computing processor.

### Description of the Related Art

Due to the recent advancement of information technology and the growing popularity of the Internet, a vast amount of information is now available in digital form. Such availability of information has provided many opportunities. Digital and online information is an advantageous source of business intelligence that is crucial to an entities survival and adaptability in a highly competitive environment.

### SUMMARY OF THE INVENTION

Various embodiments for managing skills as clusters using machine learning and a domain knowledge expert by a processor are provided. An adjacency of or similarity between one or more target skills and one or more skills of each of a plurality of entities may be determined. The adjacency of skills or similarity between skills may be used to generate one or more skill clusters. A domain knowledge expert may be used to correct the skill similarity of the one or more skill clusters. A skill demand of the one or more skill clusters may be forecasted.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a block/flow diagram depicting identifying candidates for reskilling according to an embodiment of the present invention;

FIG. 5 is a block/flow diagram depicting forecasting demand for capacity planning according to an embodiment of the present invention;

FIG. 6 is a block diagram depicting a forecast model having increased accuracy with predictions at a skill cluster level in accordance with aspects of the present invention;

FIG. 7 is a block diagram depicting a forecast model prediction of required labor for future contracts in accordance with aspects of the present invention;

FIG. 8 is a block/flow diagram depicting estimation of skill similarity using machine learning and a domain knowledge expert according to an embodiment of the present invention;

FIG. 9 is a flowchart diagram depicting an exemplary method for managing skills as a cluster using machine learning and one or more domain knowledge experts by a processor; again, in which aspects of the present invention may be realized; and

FIG. 10 is a flowchart diagram depicting an exemplary method for creating a list for reskilling by a processor; again, in which aspects of the present invention may be realized.

### DETAILED DESCRIPTION OF THE DRAWINGS

As the amount of electronic information continues to increase, the demand for sophisticated information access systems also grows. Digital or “online” data has become increasingly accessible through real-time, global computer networks. The data may reflect many aspects of various organizations and groups or individuals, including scientific, political, governmental, educational, businesses, and so forth.

Moreover, people-driven organizations tend to rely on an employee-centric organizational structure. The representation can enable the lookup of an employee's position and association within the hierarchy. Employee skills are directly or indirectly encoded in many different information sources ranging from their curriculum vitae (“CVs”) to skill-sets and projects associated with them within the organization. As a result of this, a full understanding of the skills available in an organization is typically unavailable, even with the use of various computing systems. Direct implications of this are that the resources (people) available for a particular skill is not known and that a measure of “adjacency” between people and skills does not exist.

Agile organizations need to be responsive to changing market scenarios. Demands from products and services constantly change; this results in changing skill-set requirements. Management in an organization needs to have resource information available at multiple levels of abstraction to facilitate decision making and capacity planning, both for immediate needs and for looking into the future. For instance, it is often easier to up-skill an existing employee with closely related skills than go through the process of hiring a new employee. These goals require a notion of fungibility (substitution with minimal up-skilling) between employees and in particular, the skill sets of the employee. Similarly, a measure of fungibility between skills allows organizations to improve demand forecasts for those skills considering skill usage data from prior engagements.

Furthermore, many organizations include entities (e.g., employees) that may have multiple skill sets. The employee's skill sets may be dispersed over many different resources such as, for example, information/employee profile data, a domain knowledge, resume data, and/or training data. Currently, however, adjacency between each skill is unknown and inhibits reskilling, recruiting, training, forecast demand and capacity optimization, and/or inhibits efficient usage resource capacities at a skill cluster level since many skills contain small numbers of employees.

Accordingly, various embodiments are provided herein for managing skills as a cluster using machine learning and a domain knowledge expert. An adjacency of all skills or similarity between all skills of a plurality of entities may be determined. The fungibility between one or more target skills and one or more skills of each of the plurality of entities may also be estimated. The adjacency of skills or similarity between skills may be used to generate one or more skill clusters. One or more domain knowledge experts may be used to correct similarities between the one or more skill clusters. A skill demand of the one or more skill clusters may be forecasted. Given the qualitative domain knowledge expert input into skill clusters, the difference between expert recommended skill clusters and one or more initial/original skill clusters are minimized. Said differently, similarity skill matrices may be generated from a sum of one or more initial/original similarity matrices (which may be generated from a machine learning operation) having a weighted values such that the generated similarity skill matrices will be similar to the expert recommended skill matrices by a selected threshold (e.g., 95%). In one aspect, a similarity between each skill cluster may also be defined. In an additional aspect, the present invention enables the forecast of the skill demand in a graphical user interface (GUI) so as to visualize the forecast of the various skill set clusters. A short list of candidates for reskilling may be provided. A skill centric representation of an organization may be provided. A skill planning operation may also be provided along with automatically maintaining a skills taxonomy for generating the skill similarity matrices that are compared to expert recommended skill similarity matrices.

Thus, one or more domain knowledge experts may be used herein to provide qualitative feedback information such as, for example, expert recommended skill clusters. It should be noted that calculated quantitative skill similarities (e.g., an initial calculated skill similarity matrix) may not be completely dependable. Also, the domain knowledge expert is unable to review millions (or even thousands) of the similarity measures between each pair of skills and quantify their estimates of skill similarity. However, the domain knowledge expert can review a reasonable number of skill clusters generated from the skill similarity matrix and suggest a few corrections. For example, the domain knowledge expert may move some skills to different skill clusters, split some skill clusters, and/or combine other clusters. The number of domain knowledge expert corrected skill clusters can differ from the initial number of skill clusters (e.g., generated from the initial skill matrix). As such, as corrected skill similarity matrix is generated in accordance with the domain knowledge expert corrected skill clusters compared to the initial skill clusters. The corrected skill similarity matrix is an approximation of the expert corrected skill clusters with the least amount of adjustments possible from the initial skill similarity matrix. As used herein, skill adjacency, similarity, fungibility or substitutability are used interchangeably.

In one aspect, similarity, dissimilarity, or distance between two cluster systems enables to formalize an optimization problem and to find/identify the best/optimal corrected skill similarity matrix based on expert feedback. The skill cluster system may group different objects (e.g., skills) without specifying the similarity or distance between pairs of objects (e.g., skills). As used herein, a quantifiable measure of similarity between two cluster systems grouping a set of objects into clusters may be defined. The number of clusters (e.g., skill clusters) can differ between the two cluster systems. An optimization problem may be determined and formulated to derive the best/optimal skill similarity matrix from an expert corrected system of skill clusters.

As described herein, a knowledge domain, thesaurus or ontology may be used with an employee database (DB) for the identification of one or more skills of the employee. That is, the ontology may also be used as input information for defining, describing, updating, enhancing, and/or explaining one or more skills of a person.

In one aspect, the term “domain” is a term intended to have its ordinary meaning. In addition, the term “domain” can include an area of expertise for a system or a collection of material, information, content and/or other resources related to a particular entity or subject or subjects relating to the entities. For example, a domain can refer to governmental, financial, healthcare, advertising, commerce, scientific, industrial, educational, medical and/or biomedical-specific information. A domain can refer to information related to any particular entity and associated data that may define, describe, and/or provide a variety of other data associated with one or more entities such as, for example, skills associated with a particular form of labor, work, or job task. The domain can also refer to subject matter or a combination of selected subjects.

The term ontology is also a term intended to have its ordinary meaning. In one aspect, the term ontology in its broadest sense may include anything that can be modeled as ontology, including but not limited to, taxonomies, thesauri, vocabularies, and the like. For example, an ontology may include information or content relevant to a domain of interest or content of a particular class or concept. Content can be any searchable information, for example, information distributed over a computer-accessible network, such as the Internet. A concept can generally be classified into any of a number of concepts which may also include one or more sub-concepts. Examples of concepts may include, but are not limited to, labor markets, skill information, job information, scientific information, healthcare information, medical information, biomedical information, business information, educational information, commerce information, financial information, pricing information, information about individual people, cultures, groups, sociological groups, market interest groups, institutions, universities, governments, teams, or any other information group. The ontology can be continuously updated with the information synchronized with the sources, adding information from the sources to the ontology as models, attributes of models, or associations between models within the ontology.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

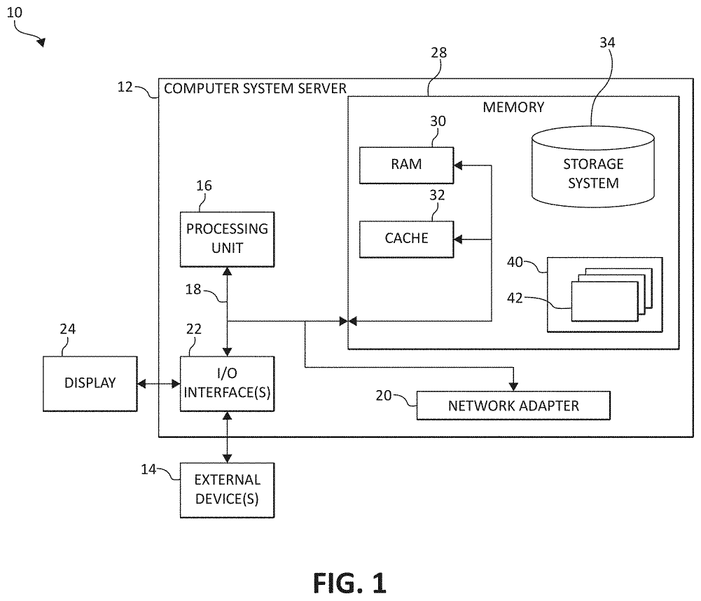

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in a moving vehicle. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

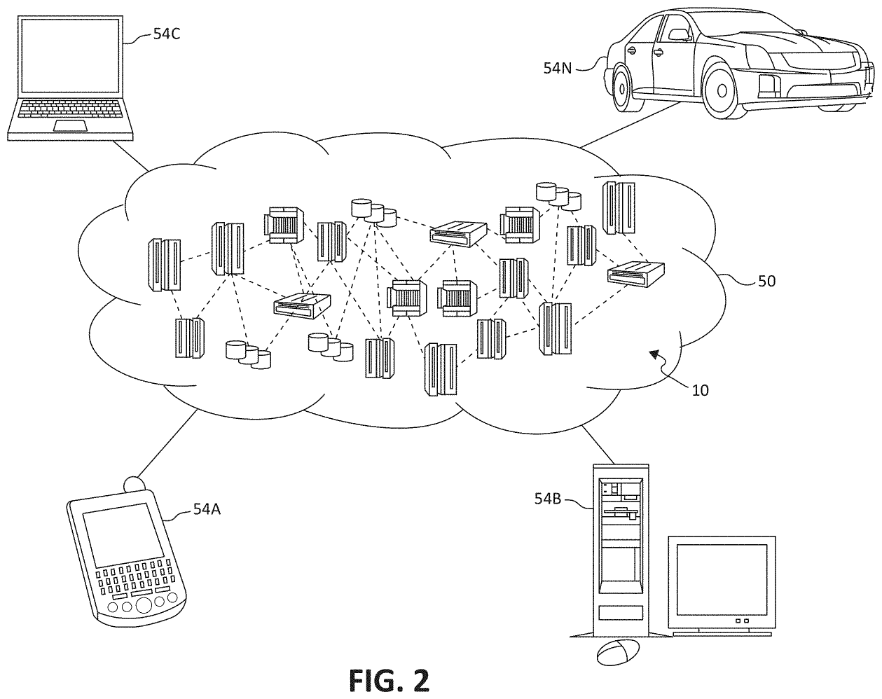

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

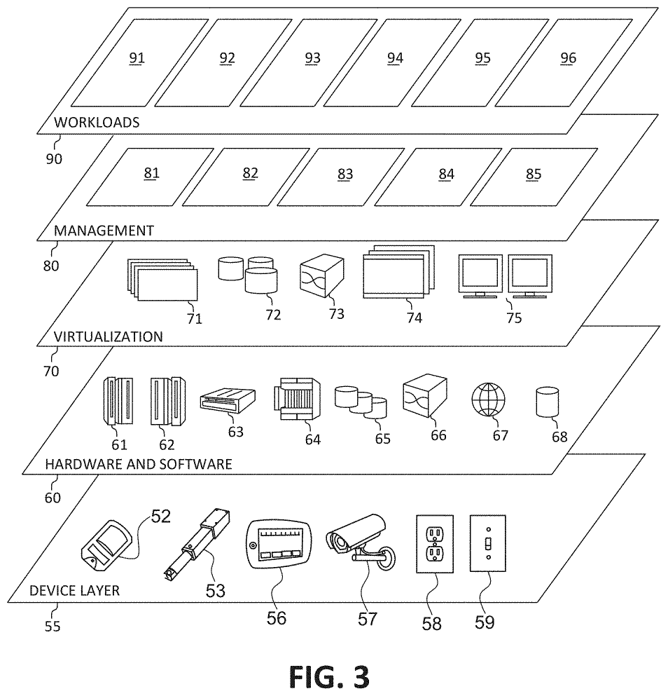

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “interne of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for managing skills as a cluster using machine learning and a domain knowledge expert. In addition, workloads and functions 96 for estimating fungibility may include such operations as data analysis (including data collection and processing from organizational databases, online information, knowledge domains, data sources, and/or social networks/media, and other data storage systems, and predictive and data analytics functions. One of ordinary skill in the art will appreciate that the workloads and functions 96 for estimating fungibility may also work in conjunction with other portions of the various abstractions layers, such as those in hardware and software 60, virtualization 70, management 80, and other workloads 90 (such as data analytics and/or fungibility processing 94, for example) to accomplish the various purposes of the illustrated embodiments of the present invention.

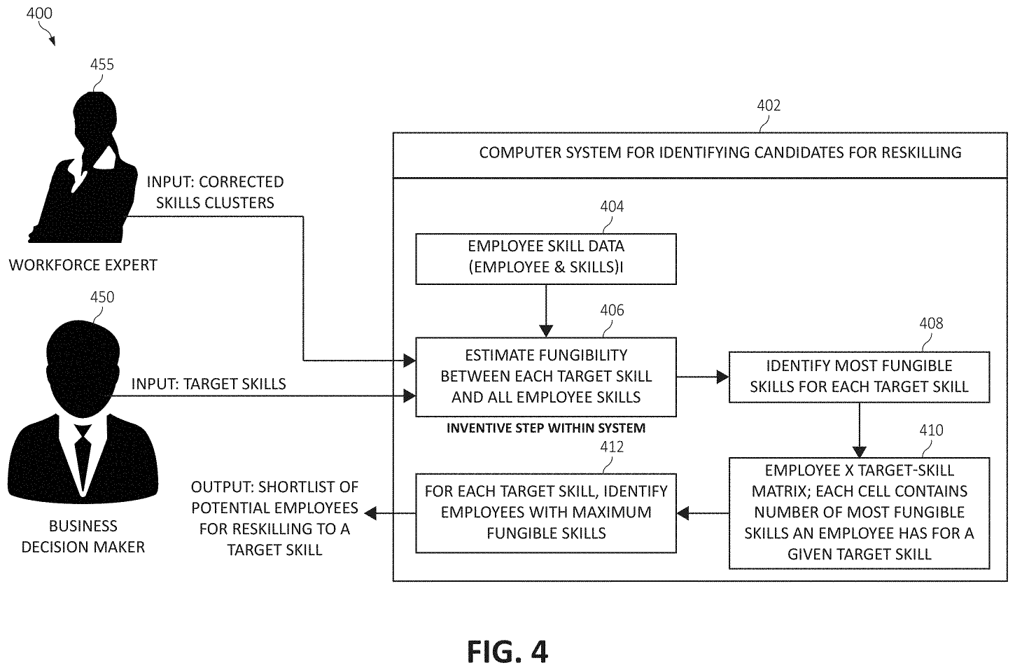

Turning now to FIG. 4, a block diagram 400 depicts identifying candidates for reskilling. In one aspect, one or more of the components, modules, services, applications, and/or functions described in FIGS. 1-3 may be used in FIG. 4. For example, computer system/server 12 of FIG. 1, incorporating processing unit 16, may be used to perform various computational, data processing and other functionality in accordance with various aspects of the present invention. Also, as shown, the various blocks of functionality are depicted with arrows designating the blocks' 400 relationships with each other and to show process flow. Additionally, descriptive information is also seen relating each of the functional blocks 400. As will be seen, many of the functional blocks may also be considered “modules” of functionality. With the foregoing in mind, the module blocks 400 may also be incorporated into various hardware and software components of a system for targeted learning and recruitment in accordance with the present invention. Many of the functional blocks 400 may execute as background processes on various components, either in distributed computing components, or on the user device, or elsewhere.

In one aspect, a computer system for identifying candidates for reskilling may be in communication with one or more users such as, for example, a business decision maker 450 and a domain knowledge expert 455 (e.g., a “workforce expert” in a particular area of knowledge, skill, and/or workforce). At block 404, skill data (e.g., employee skill data such as a resume, training data, educational data, etc.) may be collected. The collected information may be provided to block 406. At block 406, the user 450 may input into the computer system 402 one or more skills (e.g., identified or target skills) and the domain knowledge expert 455 may input one or more corrected skill clusters to estimate fungibility between each target skill and all entity (e.g., employee) skills. Those of the skills being most fungible for the target skill may be identified, as in block 408. A target-skill matrix may be used for each employee (e.g., employee “X”), as in block 410. Each cell of the target-skill matrix of each entity (e.g., employees) may contain a number of the most fungible skills the entity has/offers for the target skill. For each target skill, those of the entities having a maximum amount of fungible skills may be identified (using each target-skill matrix of each entity), as in block 412. A count list may be created that identifies those of the entities having the maximum amount of fungible skills and short list of those entities (e.g., candidate employees) to be reskilled to the target skill.

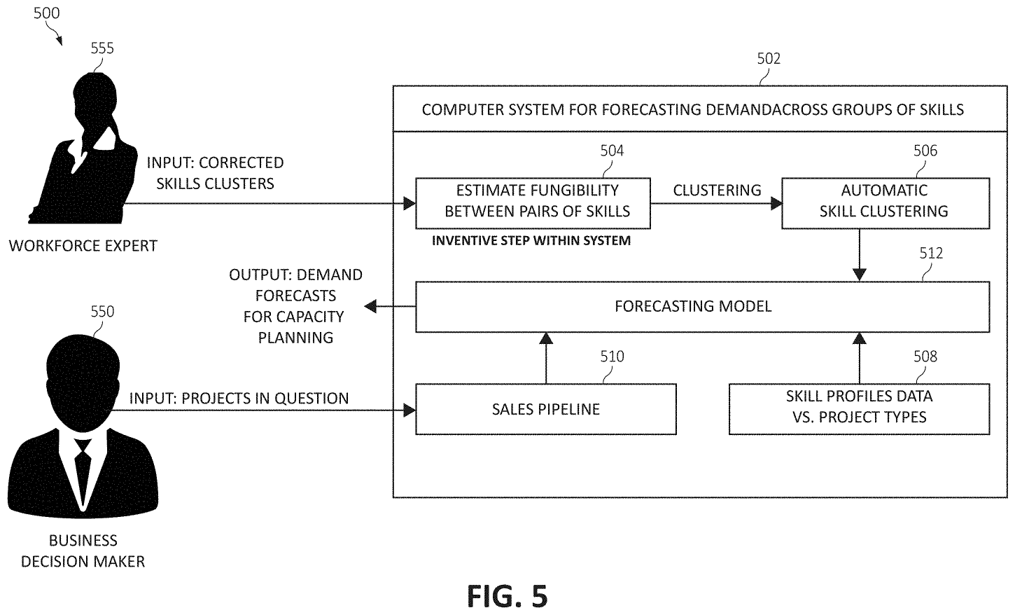

Turning now to FIG. 5, a block diagram 500 depicts forecasting demand for capacity planning. In one aspect, one or more of the components, modules, services, applications, and/or functions described in FIGS. 1-3 may be used in FIG. 5. For example, computer system/server 12 of FIG. 1, incorporating processing unit 16, may be used to perform various computational, data processing and other functionality in accordance with various aspects of the present invention.

Also, as shown, the various blocks of functionality are depicted with arrows designating the blocks' 500 relationships with each other and to show process flow. Additionally, descriptive information is also seen relating each of the functional blocks 500. As will be seen, many of the functional blocks may also be considered “modules” of functionality. With the foregoing in mind, the module blocks 500 may also be incorporated into various hardware and software components of a system for targeted learning and recruitment in accordance with the present invention. Many of the functional blocks 500 may execute as background processes on various components, either in distributed computing components, or on the user device, or elsewhere.

In one aspect, a computer system for forecasting demand (e.g., labor demand) across a group of skills may be in communication with one or more users such as, for example, a business decision maker 550 and a domain knowledge expert 555 (e.g., a “workforce expert” in a particular area of knowledge, skill, and/or workforce). At block 504, the domain knowledge expert 555 may input into the computer system 502 one or more corrected skill clusters to estimate fungibility between a pair of skills may be estimated. In one aspect, fungibility is a substitution of a skill with an alternative skill with a reduced amount of time for upskilling the one or more entities with the alternative skill as compared to an amount of time training a new entity with the alternative skill. A clustering operation may be performed to automatically generate a cluster of skills, as in block 506.

Accessing a project pipeline, from block 510, relating to one or more inputs from user 550 relating to one or more projects in question and accessing a database (DB) of one or more skill profiles of one or more entities as compared with types of projects, from block 508, a forecasting model may be provided or forecasted, as in block 512. That is, the forecast model may forecast demand (e.g., labor/skill demand) for capacity planning.

That is, fungibility may be used to generate skill clusters. It should be noted that fungibility, substitutability, similarity and adjacency may be used herein interchangeably. Substitution of skills may be performed with minimized reskilling effort, time, and/or cost (as compared to training a new skill to a new employee). An objective measure of fungibility may be obtained by combining one or more information sources of similarity between skills. The skill clusters may then be used to forecast demand according to skill information relating to one or more previous/past projects. In this way, forecasting demand at the skill cluster level (as compared to a skill of an individual at the individual level) increases accuracy and prediction for forecasting demand. As mentioned previously, labor demands for products and/or services constantly change resulting in changing skill-set requirements. Management in an organization needs to have resource information available at multiple levels of abstraction to facilitate decision making and capacity planning, both for immediate needs and for looking into the future. For instance, it is often easier to up-skill an existing employee with closely related skills than go through the process of hiring a new employee. These goals require a notion of fungibility (substitution with minimal up-skilling) between employees and in particular, the skill sets of the employee. Similarly, a measure of fungibility between skills allows organizations to improve demand forecasts for those skills considering skill usage data from prior engagements.

Thus, forecasting labor demand at a skill-level can be very useful for capacity planning, but inaccurate because of a lack of data. The demand forecasts at a high level of abstraction (e.g., abstract skill-categories) are accurate but not useful. As such, the created skill clusters provide a tradeoff between accuracy and usability in demand forecasting. The skill adjacency/fungibility measure is the means of obtaining the skill clusters. The skill adjacency/fungibility may consider and/or access multiple information sources, which is an essential characteristic of the present invention.

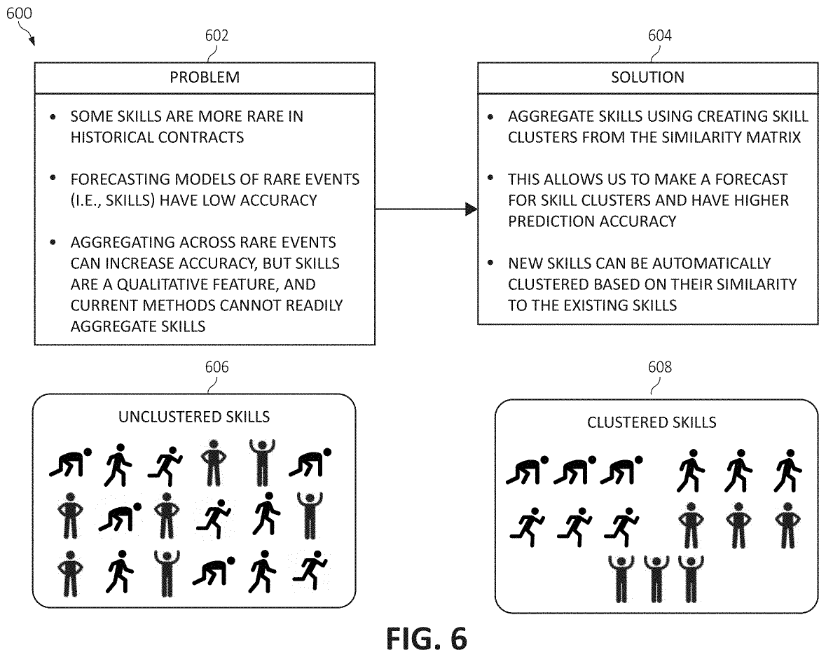

Turning now to FIG. 6 is a block diagram 600 depicts a forecast model having increased accuracy with predictions at a skill cluster level. In one aspect, one or more of the components, modules, services, applications, and/or functions described in FIGS. 1-5 may be used in FIG. 6. For example, computer system/server 12 of FIG. 1, incorporating processing unit 16, may be used to perform various computational, data processing and other functionality in accordance with various aspects of the present invention.

As illustrated, block 602 depicts a current challenge of unclustered skills 606. These challenges (e.g., problems) may include one or more skills that may be more “rare” (e.g., not as common as other skills) in previous or historical contracts of an organization. Also, forecasting models of these “rare” events (e.g., rare skills) have extremely low accuracy rates. Although aggregating across rare events may lead to increased accuracy, the current state of the art is unable to aggregate skills given that skills are a qualitative feature. However, as depicted in block 604, the present invention provides a solution that aggregates one or more skills using skill clusters creating from a similarity matrix to create skill clusters (which may include use of a domain knowledge expert for correcting the skill clusters 608 ). The clustered skills 608 enable forecasting for the skill clusters so as to increase forecast and/or prediction accuracy.

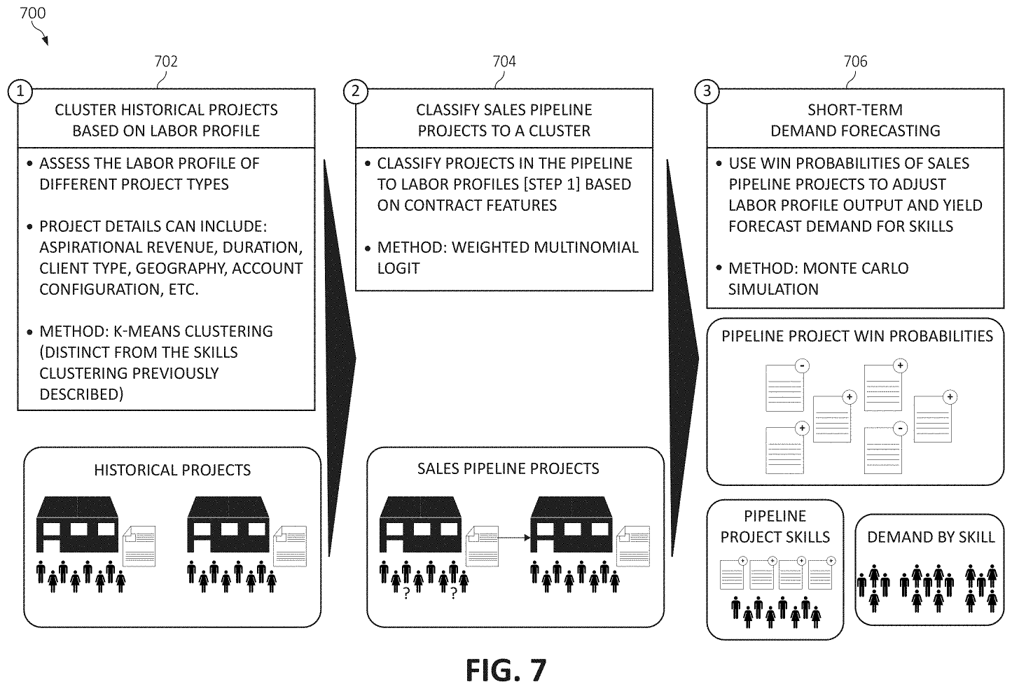

Turning now to Fig. 7, block diagram 700 depicts a forecast model prediction of required labor for future contracts. In one aspect, one or more of the components, modules, services, applications, and/or functions described in FIGS. 1-6 may be used in FIG. 7. For example, computer system/server 12 of FIG. 1, incorporating processing unit 16, may be used to perform various computational, data processing and other functionality in accordance with various aspects of the present invention.

Starting in block 702, a one or more historical projects may be clustered based on a labor profile. A labor profile of different types of project types may be assessed for using the forecast model prediction model. The details of projects may include, for example, aspirational, revenue, durations, geography, account configuration information, etc. The clustering operation for clustering the one or more historical projects may be performed using a K-means clustering operation, which may be distinct from the skill clustering operations as described above.

In block 704, one or more projects (e.g., sales pipeline projects) may be classified to a cluster. The projects in a pipeline may be classified to one or more labor profiles. A weighted multinomial-logit model, for example, may be used for the classifying.

In block 706, a forecast model prediction model may forecast a labor demand (e.g., short-term demand). The forecast model prediction model may use a probability or percentage of the wins of the one or more previously sales pipeline projects to adjust the labor profile output and may also provide or yield a forecast demand for the skills required. In one aspect, a Monte Carlo Simulation operation may be used for the short-term demand forecast.

Thus, in view of FIG. 7, the present invention provides for forecasting demand. In one aspect, an estimated fungibility may be used to cluster skills in to one or more skill-clusters. For example, a dataset of skill-cluster shares (e.g., columns of a matrix) for historical opportunities (rows of a matrix) may be created.

That is, in one aspect, the present invention provides for skill demand forecasting that may include fungibility estimation used to cluster skills into skill-clusters. A dataset of skill-cluster may be created. That is, dataset of skill-cluster shares of historical opportunities may be created (e.g., shares of columns and/or rows of historical opportunities of a taxonomy).

In one aspect, a K-means clustering operation was performed on the skill-cluster shares. The number of skill clusters may be empirically chosen such as, for example, a selected number (e.g., 17 ). These skill clusters may be called labor profiles. A weighted multinomial-logit model may be used and trained using historical opportunity features (e.g., revenue, duration, etc.) to predict the labor profiles. The weight may be based on claim recency (e.g., a time decay function) and a size (e.g., a total number of claim hours). An opportunity with many claims that recently occurred is given the most weight. The reason for this is because recent, large claims are more likely to decide the labor profiles needed for future opportunities

The trained weighted multinomial-logit model may be applied on pipeline opportunities (i.e., represented by features such as, for example, revenue, duration of job, etc.) to predict the probability of the opportunity using the labor profiles (e.g., the 17). Weights are not used for this step.

A dot product of the predicted probabilities with the weighted average shares of each labor profile may provide an estimate of predicted share of skill-clusters per pipeline opportunity. Using a separate linear model between expected revenue and hours, a total number of hours for each pipeline opportunity may be obtained. When multiplied by the predicted skill-cluster shares, predicted hours per skill cluster per potential opportunity may be obtained. A machine learning operation and/or simulation operation such as, for example, a Monte Carlo Simulation operation may be used for the short-term demand forecast. The Monte Carlo Simulation operation may be used for the short-term demand forecast to generate win probabilities. For example, for 100 thousand simulations, a 1 or 0 may be assigned to each pipeline opportunity based on the win probability of each simulation. The product of these simulations, along with the expected hours and a summation of the hours for each skill cluster may yield 100 thousand possible expected hours for each skill cluster. This distribution may be used to derive a demand forecast with confidence intervals for each skill cluster, which may be used as a final output.

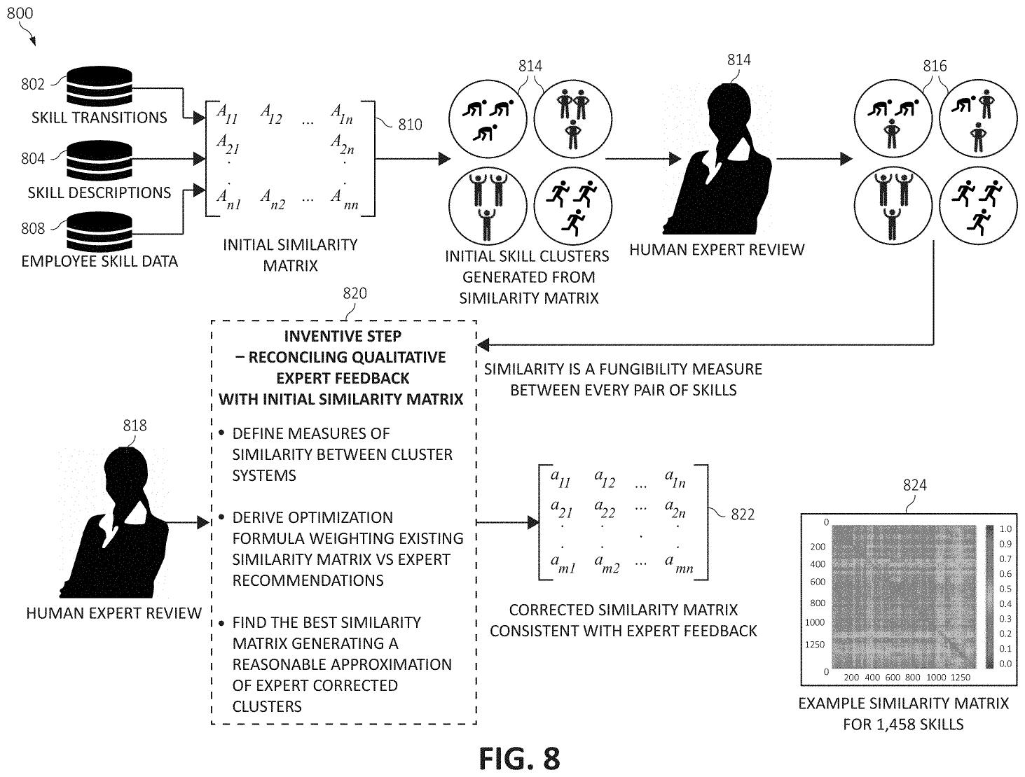

FIG. 8 is a block/flow diagram for estimating skill similarity using machine learning and a domain knowledge expert. In one aspect, one or more of the components, modules, services, applications, and/or functions described in FIGS. 1-5 may be used in FIG. 8. For example, computer system/server 12 of FIG. 1, incorporating processing unit 16, may be used to perform various computational, data processing and other functionality in accordance with various aspects of the present invention.

As a preliminary matter, FIG. 8 depicts skill similarity estimation from data that may include historical transitions (e.g., people skill transitions) and skill descriptions (e.g., semantic similarity). That is, FIG. 8 depicts estimation of skill similarity from one or more data sources such as, for example, skill transitions 802 (e.g., skill transitions data), skill descriptions 804 (e.g., skill descriptions data), and/or employee skills data 808 (each of which may be stored in one or more databases).

In one aspect, for estimating skill similarities from one or more data sources from the skill transitions 802, the skill descriptions 804, and/or the employee skills data 808 may be determined according to semantic similarity between one or more skills included in one or more data sources.

The initial skill similarity matrix 810 may be used to generate one or more initial skill clusters 812. A domain knowledge expert 814 may review and apply feedback to the one or more initial skill clusters 812 to generate one or more corrected skill clusters 816.

In order to generate the one or more corrected skill clusters 816, consider the following additional operations using the feedback from the domain knowledge expert 814. As in block 820, one or more measures of similarity between each skill cluster may be defined. An optimization formula may be determined/derived that may weigh the initial similarity matrix 810 compared to one or more domain knowledge expert 814 recommendations (e.g., compare the initial similarity matrix 810 to one or more domain knowledge expert similarity matrices). A most optimal similarity matrix of each entity (e.g., employee) may be identified according to the domain knowledge expert 814 recommendations. That is, qualitative domain knowledge expert 814 feedback may be used to reconcile the initial similarity matrix 810. A corrected similarity matrix 822 may be generated that includes the domain knowledge expert 814 feedback.

By way of example only, block 824 depicts an exemplary fungibility matrix for one or more target skills tested (e.g., 1458 skills tested). Assume, for example, the set of 1458 skills is from a large information technology (“IT”) organization. Each skill may have associated metadata, capabilities, and descriptions associated therewith.

In view of the functionality of FIG. 8, consider the follow for inferring as similarity matrix from a cluster system, defining similarities between at least two cluster systems using one or more operations, and estimating skill similarity.

For inferring one or more similarity matrices (e.g., sufficient similarity matrices) from a cluster system A, assume there is an initial/original skill similarity matrix Ŝ having rows and columns of skills such as, for example, skills S101, S102, S103, etc. The domain knowledge expert may recommend skill cluster system Cₒ classifying all the skills into clusters Cₒ1, Cₒ2, etc. Each of the skills may be sorted and aligned with domain knowledge expert recommended clusters. It should be noted that the clusters generated from the skill similarity matrix Ŝ are different from the domain knowledge expert recommended clusters.

A sufficient skill similarity matrix \hat{D} may generate the domain knowledge expert recommended clusters and the sufficient skill similarity matrix \hat{D} is sufficiently similar (e.g., substantially or having a least amount of adjustments) to the original skill similarity matrix Ŝ.

The sufficient skill similarity matrix \hat{D} may be derived from the original skill similarity matrix Ŝ by modifying one or more elements of the diagonal submatrices (Cₒ1, Cₒ1) (Cₒ2, Cₒ2, (Cₒ3, Cₒ3) etc. A maximal similarity “q” between all skills in each cluster (e.g. Cₒ2) and the skills in all other clusters (q2) may be determined/calculated. In one aspect, the maximal element of all non-diagonal sub-matrices in the group of columns may be aligned with the skills Cₒ2. The elements in the diagonal submatrix (c02, c02) that are less than or equal to q2 may be modified making them larger than q2. It should be noted that in the sufficient skill similarity matrix \hat{D} only the elements in the diagonal submatrices have been modified.

Also, other sufficient similarity matrices may be defined such as, for example, a matrix where only elements in the nondiagonal submatrices are modified to be less than the minimal element in the corresponding diagonal submatrix. Other sufficient matrices can be defined as having all diagonal submatrices elements as 1 and all nondiagonal submatrices elements as 0.

For optimizing the sufficient similarity matrices inferred from a cluster systems, minimal weight parameters (e.g., w, u, v) may be combined with the initial skill similarity matrix Ŝ and skill similarity matrix \hat{D}, Ê, \hat{F} into similarity matrix \hat{R} such that similarity matrix \hat{R} generates a cluster system similar to the domain knowledge expert may recommend skill cluster system Cₒ according to equation 1:

\hat{R}=(1−w−u−v)*Ŝ+\hat{D}+u*Ê+v*\hat{F} (1).

For each combination of weight w, u, v, a cluster system B (w, u, v) utilizing weighted PAM clustering on the similarity matrix \hat{R} may be generated. The similarity matrix \hat{R} may be considered a best/optimal approximation of the corrected similarity matrix when the similarity Y{B (w, u, v), C} exceeds a pre-defined threshold τ (e.g., threshold τ=95%). In some aspects, when the expert recommended clusters are substantially identical (little differences/modification) to the clusters generated by the initial/original skill similarity matrix Ŝ, equation (1) above can be simplified neglecting weights u=0 and v=0 so only minimal weight w is to be found as in equation 2:

\hat{R}=(1−w)*Ŝ+w*\hat{D} (2).

Additionally, the similarities between two cluster systems may also be defined. It should be noted that currently, identifying similarities between two cluster systems when the number of clusters in each system can be different is difficult and almost impossible to determine. For example, a basic cluster system (e.g., one level, non-hierarchical) does not provide any similarities between skills or objects, but only indicates which skills or object belong to the same cluster and which belong to different clusters.

Accordingly, the present invention provides for defining similarities between two cluster systems. In one aspect (e.g., “method A”), a rectangular matrix with K columns (the number of generated clusters) and L rows (the number of expert recommended clusters) may be defined. Each matrix element may be computed as a Jaccard index (equation 3), the ratio of intersection between two clusters (e.g., common skills) to the union of two clusters (e.g., the total number of distinct skills in two clusters). The similarity between two cluster systems may be defined as a generalized determinant of the rectangular matrix (equation 4) (e.g., the square root of the determinant of the square matrix that is the product of transposed and the original rectangular matrices, and the number of rows and columns in this square matrix is the minimum of K and L).

In one aspect, cluster skill similarity matrix Ĵ may be defined based on the union and intersection between each cluster pair, the Jaccard index of each matrix element. The rows and the columns of cluster skill similarity matrix Ĵ (i, k) may be the clusters from the cluster system A and cluster system B, respectively. The Jaccard index may be calculated according to the following equation:

$$\hat{J} ( i , k ) = \frac{{b}_{i} ⋂ {c}_{k}}{{b}_{i} ⋃ {c}_{k}} . \qquad ( 3 )$$

Also, the similarity Y{B, C} between the cluster system A and cluster system B may be defined as the determinant of rectangular skill similarity matrix Ĵ. Without the loss of generality, it may be assumed that K is less than or equal to L (“K≤L”) and the product matrix Ĵ′·Ĵ in equation (4), following, is a K*K square matrix:

Y₁=ndet(Ĵ)=\sqrt{det(Ĵ′·Ĵ)} (4).

In an additional aspect for defining similarities between two cluster systems (e.g., “method B”), each basic (one level, non-hierarchical) cluster system classifying “N” number of skills (objects) may be represented as a rectangular matrix with K columns (e.g., the number of clusters) and N rows (e.g., the number of skills). Each matrix element may be computed as a reciprocal of square root of the number of skills hₖ in each cluster k if the skill belongs to the particular cluster (computing as 0 otherwise) according to the following equation:

$$\hat{B} ( n , k ) = ; \{ \begin{matrix}{\frac{1}{\sqrt{{h}_{k}}} }^{; skill n ∈ cluster k} \\ {0}_{; skill n ∉ cluster k}\end{matrix} . \qquad ( 5 )$$

The similarity between two cluster systems may be defined as the generalized determinant of the dot product of two rectangular matrices such as, for example, the square root of the determinant of the square matrix that is the product of transposed and the rectangular matrices, and the number of rows and columns in the square matrix is the minimum of K and L according to the following equation:

$${ϒ}_{2} = \sqrt{\frac{K}{L}} ndet ( {\hat{C}}^{′} \cdot \hat{B} ) = \sqrt{\frac{K}{L} det ( {\hat{B}}^{′} \cdot \hat{C} ) \cdot ( {\hat{C}}^{′} \cdot \hat{B} ) )} . \qquad ( 6 )$$

In an additional aspect for defining similarities between two cluster systems (e.g., “method C”), each basic (one level, non-hierarchical) cluster system classifying “N” number of skills (objects) may be represented as a rectangular matrix with K columns (e.g., the number of clusters) and N rows (e.g., the number of skills). Each matrix element may be a value of 1 if the skill belongs to this cluster and 0 otherwise, according to equation 7. Also, it may be assumed that the skills are ordered exactly in the same order in matrices \hat{B} and Ĉ. Also, larger N*N matrices [symbol] and [symbol] as dot products according to equation 8 and 9.

$$\hat{B} ( n , k ) = ; \{ \begin{matrix}{1}^{; skill n ∈ cluster k} \\ {0}_{; skill n ∉ cluster k}\end{matrix} , \qquad ( 7 )$$

[symbol]

=\hat{B}·\hat{B}′ (8),

[symbol]

=Ĉ·Ĉ′ (9).

Matrices [symbol] and [symbol] have N skills as their rows and columns with their elements (e.g., [symbol] (n₁, n₂) illustrated as follows:

$${\hat{B}}_{2} ( {n}_{1} , {n}_{2} ) = ; \{ \begin{matrix}{1}^{; skill {n}_{1} , {n}_{2} ∈ the same cluster} \\ {0}_{; skill {n}_{1} , {n}_{2} ∉ the same cluster}\end{matrix} . \qquad ( 10 )$$

The combined matrix Ĝ may be defined as the logical biconditional of matrices [symbol] and [symbol] . Matrix Ĝ may have its elements equal to one (“1”) when the corresponding matrix elements [symbol] and [symbol] are the same (e.g., two skills belong or do not belong to the same cluster in both cluster systems B and C), and 0 otherwise. Also, the similarity Y{B, C} between the cluster system B and cluster system C may be defined as the sum of all non-diagonal matrix Ĝ elements normalized by the total number of non-diagonal elements illustrated as follows:

$${ϒ}_{3} \{ B , C \} = \frac{{\sum }_{i \neq j} G ( i , j )}{N ( N - 1 )} . \qquad ( 11 )$$

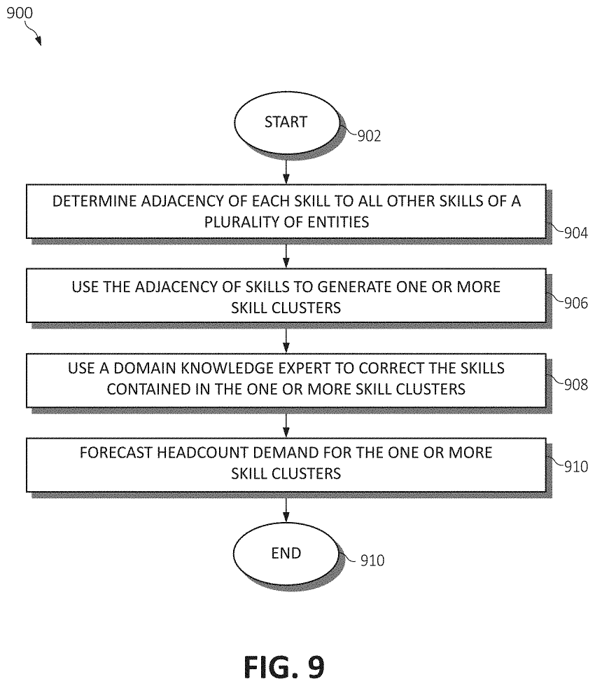

Turning now to FIG. 9, a method 900 for managing skills as a cluster using machine learning and a domain knowledge expert by a processor is depicted, in which various aspects of the illustrated embodiments may be implemented. The functionality 900 may be implemented as a method executed as instructions on a machine, where the instructions are included on at least one computer readable medium or one non-transitory machine-readable storage medium. The functionality 900 may start in block 902.

An adjacency of each skill to all other skills of a plurality of entities may be determined, as in block 904. The adjacency of skills may be used to generate one or more skill clusters, as in block 906. A domain knowledge expert may be used to correct the skills contained in the one or more skill clusters, as in block 908. A headcount demand for the one or more skill clusters (e.g., corrected skill clusters) may be forecasted, as in block 910. The functionality 900 may end in block 912.

In one aspect, in conjunction with and/or as part of at least one block of FIG. 9, the operation of 900 may include one or more of each of the following. The operation of 900 may estimate fungibility between one or more target skills and one or more skills of each of the plurality of entities. The fungibility may be a substitution of a skill with an alternative skill with a reduced amount of time for upskilling the one or more entities with the alternative skill as compared to an amount of time training a new entity with the alternative skill.

The operation of 900 may use the fungibility to generate the one or more skill clusters, apply feedback from the domain knowledge expert to correct the one or more skill clusters, and/or forecast the skill demand at a level of the one or more corrected skill clusters.

The one or more skill clusters may be reconciled with feedback from the domain knowledge expert to generate one or more corrected skill clusters. The operation of 900 may generate one or more similarity matrices according to the determined adjacency of skills, apply feedback from the domain knowledge expert to correct the one or more similarity matrices, and/or generate one or more corrected similarity matrices according to the feedback. Those of the one or more skills being most fungible for a target skill and those of the plurality of entities having a maximum amount of fungible skills may be identified.

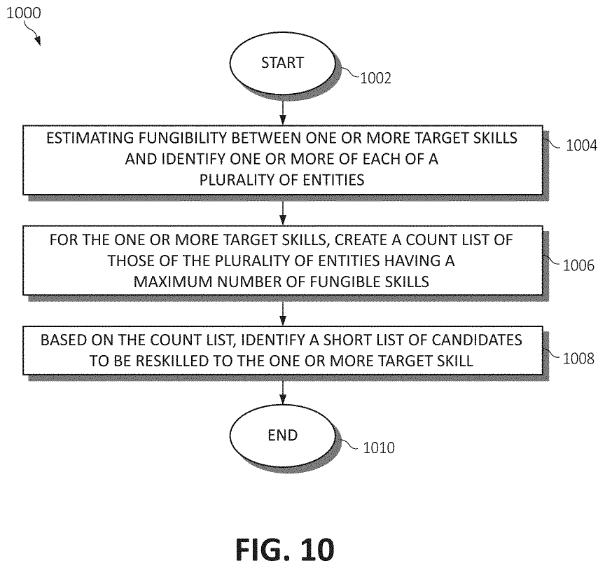

Turning now to FIG. 10, a method 1000 for creating a list for reskilling by a processor is depicted, in which various aspects of the illustrated embodiments may be implemented. That is, FIG. 10 is a flowchart of an additional example method 1000 for estimating substitutability between skills by combining skill similarities from one or more sources in a computing environment according to an example of the present invention. The functionality 1000 may be implemented as a method executed as instructions on a machine, where the instructions are included on at least one computer readable medium or one non-transitory machine-readable storage medium. The functionality 1000 may start in block 1002.

A fungibility may be estimated between one or more target skills and one or more skills of each of a plurality of entities, as in block 1004. For the one or more target skills, a count list may be created of those of the plurality of entities having a maximum number of fungible skills, as in block 1006. Based on the count list, a short list of candidates to be reskilled to the one or target skills may be identified, as in block 1008. The functionality 1000 may end in block 1010.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for managing skills as a cluster using machine learning and a domain knowledge expert by a processor, comprising:
determining adjacency of skills of one or more target skills and one or more skills of each of a plurality of entities;
using the adjacency of skills to generate one or more skill clusters;
correcting the one or more skill clusters using the one or more domain knowledge experts; and
forecasting skill demand of the one or more skill clusters or corrected skill clusters.

2. The method of claim 1, further including estimating fungibility between one or more target skills and one or more skills of each of the plurality of entities, wherein fungibility is a substitution of a skill with an alternative skill with a reduced amount of time for upskilling the one or more entities with the alternative skill as compared to an amount of time training a new entity with the alternative skill.

3. The method of claim 2, further including:
using the fungibility to generate the one or more skill clusters;
applying feedback from the one or more domain knowledge experts to correct the one or more skill clusters; and
forecasting the skill demand at a level of the one or more corrected skill clusters.

4. The method of claim 1, further including reconciling the one or more skill clusters with feedback from the domain knowledge expert to generate one or more corrected skill clusters.

5. The method of claim 1, further including:
generating one or more similarity matrices according to the determined adjacency of skills;
applying feedback from the domain knowledge expert to correct the one or more similarity matrices; and
generating one or more corrected similarity matrices according to the feedback.

6. The method of claim 5, further including identifying those of the one or more skills being most fungible for a target skill.

7. The method of claim 5, further including identifying those of the plurality of entities having a maximum amount of fungible skills.

8. A system for managing skills as a cluster using machine learning and the one or more domain knowledge experts, comprising:
one or more computers with executable instructions that when executed cause the system to:
determine adjacency of one or more target skills and one or more skills of each of a plurality of entities;
use the adjacency of skills to generate one or more skill clusters;
correct the one or more skill clusters using the one or more domain knowledge experts; and
forecast skill demand of the one or more skill clusters.

9. The system of claim 8, wherein the executable instructions estimate fungibility between one or more target skills and one or more skills of each of the plurality of entities, wherein fungibility is a substitution of a skill with an alternative skill with a reduced amount of time for upskilling the one or more entities with the alternative skill as compared to an amount of time training a new entity with the alternative skill.

10. The system of claim 9, wherein the executable instructions:
use the fungibility to generate the one or more skill clusters;
apply feedback from the domain knowledge expert to correct the one or more skill clusters; and
forecast the skill demand at a level of the one or more corrected skill clusters.

11. The system of claim 8, wherein the executable instructions reconcile the one or more skill clusters with feedback from the domain knowledge expert to generate one or more corrected skill clusters.

12. The system of claim 8, wherein the executable instructions
generate one or more similarity matrices according to the determined adjacency of skills;
apply feedback from the one or more domain knowledge experts to correct the one or more similarity matrices; and
generate one or more corrected similarity matrices according to the feedback.

13. The system of claim 12, wherein the executable instructions identify those of the one or more skills being most fungible for a target skill.

14. The system of claim 12, wherein the executable instructions identify those of the plurality of entities having a maximum amount of fungible skills.

15. A computer program product for, by a processor, forecasting demand across groups of skills, the computer program product comprising a non-transitory computer-readable storage medium having computer-readable program code portions stored therein, the computer-readable program code portions comprising:
an executable portion that determines adjacency of one or more target skills and one or more skills of each of a plurality of entities;
an executable portion that uses the adjacency of skills to generate one or more skill clusters;
an executable portion that corrects one or more skill clusters using one or more domain knowledge experts; and
an executable portion that forecasts skill demand of the one or more skill clusters.

16. The computer program product of claim 15, further including an executable portion that estimates fungibility between one or more target skills and one or more skills of each of the plurality of entities, wherein fungibility is a substitution of a skill with an alternative skill with a reduced amount of time for upskilling the one or more entities with the alternative skill as compared to an amount of time training a new entity with the alternative skill.

17. The computer program product of claim 15, further including an executable portion that:
uses the fungibility to generate the one or more skill clusters;
applies feedback from the one or more domain knowledge experts to correct the one or more skill clusters; and
forecasts the skill demand at a level of the one or more corrected skill clusters.

18. The computer program product of claim 15, further including an executable portion that reconciles the one or more skill clusters with feedback from the domain knowledge expert to generate one or more corrected skill clusters.

19. The computer program product of claim 15, further including an executable portion that:
generates one or more similarity matrices according to the determined adjacency of skills;
applies feedback from the domain knowledge expert to correct the one or more similarity matrices; and
generates one or more corrected similarity matrices according to the feedback.

20. The computer program product of claim 19, further including an executable portion that:
identifies those of the one or more skills being most fungible for a target skill; and
identifies those of the plurality of entities having a maximum amount of fungible skills.
